(19) United States
(12) Patent Application Publication
(10) Pub. No.: US 2014/0234468 A1
(43) Pub. Date: Aug. 21, 2014

(54) MOLD BLANK, MASTER MOLD, METHOD OF MANUFACTURING COPY MOLD AND MOLD BLANK

(71) Applicants: Kazutake Taniguchi, Tokyo (JP); Shuji Kishimoto, Tokyo (JP); Takashi Sato, Tokyo (JP)

(72) Inventors: Kazutake Taniguchi, Tokyo (JP); Shuji Kishimoto, Tokyo (JP); Takashi Sato, Tokyo (JP)

(73) Assignee: HOYA CORPORATION, Tokyo (JP)

(21) Appl. No.: 14/347,748

(22) PCT Filed: Sep. 12, 2012
(86) PCT No.: PCT/JP2012/073259

§ 371 Date: Apr. 8, 2014

(30) Foreign Application Priority Data
Sep. 30, 2011 (JP) 2011-217672

(51) Int. Cl. B29C 59/02; B29C 33/56; C09D 1/00

(52) U.S. Cl. CPC B29C 59/022; C09D 1/00; B29C 33/56; B29C 2059/023; B29C 2033/0094
USPC 425/385; 428/336; 428/432; 428/446; 106/286.1; 427/133

(57) ABSTRACT

There is provided a mold blank comprising a hard mask, wherein the hard mask layer has a composition containing chromium, nitrogen, and oxygen and has a content variation structure in which content of the nitrogen is varied continuously or gradually in a layer thickness direction and content of the oxygen is varied in the layer thickness direction continuously or gradually substantially in an opposite direction to the nitrogen.

### TECHNICAL FIELD

The present invention relates to a mold blank for imprint, a master mold for imprint, and a method of manufacturing a copy mold for imprint and a mold blank for imprint.

### DESCRIPTION OF RELATED ART

In recent years, as magnetic media responding to high recording density, patterned media for magnetically separating and forming a data track, is proposed. As the patterned media, Discrete Track Recording Media (called “DTR media” hereafter) for magnetically separating and forming the data track of a magnetic disc, and Bit Patterned Media (called “BPM” hereafter) for recording a signal as a bit pattern (dot pattern) so that the DTR media are further densified and developed, are known.

The patterned media such as DTR media and BPM are generally mass-produced using an imprint technique (or also called a “nano-imprint technique”). In the imprint technique, the patterned media (for example BPM) is fabricated using a master mold (also called a “master disc”) or a copy mold (also called a “working replica”) obtained by transferring and copying once or multiple numbers of times the master mold as an original mold, and transferring a pattern of the master mold or the copy mold onto a transfer material.

The master mold is manufactured using a mold blank obtained by sequentially forming a hard mask layer and a resist layer on a substrate. Specifically, the master mold is formed by forming a resist pattern by performing a specific pattern exposure and development to the resist layer in the mold blank, and further by applying etching to a hard mask layer and a substrate in the mold blank using the resist pattern as a mask, and finally forming a specific irregular pattern on the substrate.

Further, the copy mold is manufactured using the mold blank, similarly to the case of the master mold. However, the case of the copy mold is different from the case of the master mold in a point that the resist pattern is formed by transferring the irregular pattern of the original mold onto the resist layer in the mold blank.

By passing through such a manufacturing process, an etching resistance is required for the hard mask layer in the mold blank for imprint, when applying etching to a lower layer (namely substrate). Also, satisfactory etching (namely securing of a sufficient etching rate) is required for the hard mask layer when using an upper layer (namely resist layer) as a mask. Further, when the master mold is manufactured (namely when pattern drawing is performed onto the resist layer), electro-conductivity is requested for preventing a charge-up.

As described above, a layered film consisting with a chromium (Cr) containing film and also a conductive film containing tantalum (Ta) is proposed as a hard mask layer in the mold blank for imprint(for example, see patent document 1).

### PRIOR ART DOCUMENT

### Patent Document

Patent document 1: Japanese Patent Laid Open Publication No.2011-96686

### SUMMARY OF THE INVENTION

### Problem to be Solved by the Invention

Incidentally, in recent years, fine pattern cycle (pitch) and fine widths of a recessed part and a projection part in an irregular pattern, are requested in the patterned media. Such a fine irregular pattern has been highly requested day by day, and if the BPM is taken as an example, a fine irregular pattern of 50 nm pitch (recess:projection=1:1) level has been requested in recent years. In order to satisfy this request, the irregular pattern in the original mold is required to be finer when fabricating the BPM. Further, the fine irregular pattern is required to be formed on the master mold which is a base of the original mold.

In order to respond to such a fine irregular pattern, it is preferable to form a thin hard mask layer of the mold blank for imprint which is a base of the master mold. Specifically, it can be considered that a film thickness of the hard mask layer is set to 5 nm or less for example.

However, in the hard mask layer configured as described in patent document 1, it is difficult to respond to thinning the hard mask layer at the abovementioned level, due to a layered film structure. This is because there is a necessity for extremely thinning each of the laminated layers, for thinning the whole body of the hard mask layer. Further, electro-conductivity for preventing a charge-up is also requested while responding to the necessity for thinning the hard mask layer, for the purpose of use as the master mold. Namely, in a case of a conventional hard mask layer, it is difficult to form the thin hard mask layer, and even in a case of the thin film, there is a necessity for securing electro-conductivity (in a case of the use as the master mold), thus this could make difficult to respond to the formation of the fine pattern with high precision.

Meanwhile, regarding the hard mask layer, adhesion to an upper layer (namely a resist layer) is required to be sufficiently secured. Particularly, when the hard mask layer is used in an imprint technique, there is a possibility that pattern transfer cannot be satisfactorily performed if the adhesion is not secured. Therefore the adhesion to the resist layer is considerably important. Namely, even in a case that the adhesion between the hard mask layer and the resist layer cannot be secured, the fine pattern cannot be formed with high precision, due to the generation of peel-off of the resist.

Therefore, in order to realize the formation of a fine pattern with high precision when manufacturing a mold in a mold blank including a hard mask layer, an object of the present invention is to achieve a thin hard mask film and simultaneously to make possible to secure electro-conductivity for a master mold production, and moreover to attain the adhesion between hard mask layer and the upper layer. As result of this, to provide a master mold and a copy mold with a fine and high precision irregular pattern is the object.

### Means for Solving the Problem

In order to achieve the abovementioned object, the present invention is provided.

In order to achieve this object, inventors of the present invention study on thinning the film of a hard mask layer of a mold blank in which the hard mask layer is formed on a substrate. Regarding this point, thinning the hard mask layer could be achieved by not employing a conventional layered film structure for example. However, in this case, there is a risk of lessening electro-conductivity of the hard mask layer under an influence of a surface oxidation described later. Such an influence of the surface oxidation could become too significant to be ignored, particularly when thinning the hard mask layer.

Further, the inventors of the present invention study on a composition structure of the mold blank in which the hard mask layer is formed on a substrate, by performing composition analysis of the hard mask layer in a layer thickness direction. As a result, it is found that the effect of the treatment during the production (for example, baking before resist coating) is possible to make the hard mask layer oxidation from a surface side. Such an oxidation of the hard mask layer results in lessening the electro-conductivity of the hard mask layer, and therefore is not preferable if the oxidation spreads to the whole body of the hard mask layer in the layer thickness direction.

However, if baking before resist coating is performed to the mold blank, the adhesion between the hard mask layer and a resist layer which is an upper layer of the hard mask layer can be improved, compared with a case that the baking before resist coating is not performed. Therefore, it can be said that the surface oxidation of the hard mask layer is effective for securing the adhesion to the resist layer.

Therefore, the inventors of the present invention obtain a knowledge that when thinning the hard mask layer, securing the electro-conductivity of the hard mask layer, and securing the adhesion to the upper layer of the hard mask layer, are mutually contradictory object matters if the oxidation of the hard mask layer is focused. Namely, it is difficult to obtain both of securing electro-conductivity and securing adhesion, only by oxidizing the hard mask layer.

As a result of further strenuous efforts by the inventors of the present invention regarding this point, it is found that the electro-conductivity of the hard mask layer can be maintained to be high even if the surface oxidation occurs in the hard mask layer, by suitably varying a content of each composition of the hard mask layer in a layer thickness direction while containing a material that functions as an oxidation inhibiting material in the hard mask layer, thus suppressing the spread of the oxidation of the hard mask layer over the whole body of the hard mask layer in the layer thickness direction.

The present invention is provided based on the abovementioned new concept by the inventors of the present invention.

According to a first aspect of the present invention, there is provided a mold blank including a substrate and a hard mask layer formed on the substrate as a mask material when etching is applied to the substrate, wherein the hard mask layer has a composition containing chromium, nitrogen, and oxygen and has a content variation structure in which content of the nitrogen is varied continuously or gradually in a layer thickness direction and content of the oxygen is varied in the layer thickness direction continuously or gradually substantially in an opposite direction to the nitrogen.

According to a second aspect of the present invention, there is provided the mold blank of the first aspect, wherein in the content variation structure, the content of the nitrogen is high toward the substrate, and the content of the oxygen is high toward a surface opposite to the substrate.

According to a third aspect of the present invention, there is provided the mold blank of the second aspect, wherein the nitrogen has a function of inhibiting oxidation in a layer, and the oxygen has a function of improving an adhesion when a resist layer is formed on a surface.

According to a fourth aspect of the present invention, there is provided the mold blank of the third aspect, wherein a film thickness of the hard mask layer is 5 nm or less.

According to a fifth aspect of the present invention, there is provided the mold blank of the third aspect, wherein the substrate is made of quartz or silicon.

According to a sixth aspect of the present invention, there is provided the mold blank of the third aspect, wherein the hard mask layer includes a portion in which the content of the nitrogen is 30 [at %] or more.

According to a seventh aspect of the present invention, there is provided a mold blank including a substrate and a hard mask layer formed on the substrate as a mask material when etching is applied to the substrate, wherein the hard mask layer has a composition including a metal material having resistance to etching and electro-conductivity, and has an oxidized portion formed in the vicinity of a surface area on an opposite side of the substrate, and containing an oxidation inhibiting material in a substrate side area for inhibiting a spread of the oxidized portion over the whole body of the hard mask layer in a layer thickness direction.

According to an eighth aspect of the present invention, there is provided the mold blank of the seventh aspect, wherein the oxidation inhibiting material is nitrogen.

According to a ninth aspect of the present invention, there is provided a master mold, having an irregular pattern and formed of the mold blank described in any one of the first to eighth aspects.

According to a tenth aspect of the present invention, there is provided a copy mold, having an irregular pattern and formed of the mold blank described in any one of the first to eighth aspects.

According to an eleventh aspect of the present invention, there is provided a method of manufacturing a mold blank including a substrate and a hard mask layer formed on the substrate as a mask material when etching is applied to the substrate, the method including:

a first step of forming the hard mask layer having a composition containing chromium and nitrogen on the substrate; and

a second step of forming an oxidized portion in the vicinity of a surface area on an opposite side of the substrate in the hard mask layer, and inhibiting a spread of the oxidized portion over the whole body of the hard mask layer in a layer thickness direction by making the nitrogen function as an oxidation inhibiting material.

### EFFECT OF THE INVENTION

According to the present invention, in the mold blank including the hard mask layer, the adhesion between the hard mask layer and the upper layer can be secured while securing the electro-conductivity of the hard mask layer, even when responding to the thinning of the hard mask layer. As a result, the master mold and the copy mold can be obtained, in which fine irregular patterns are formed with high precision.

### BRIEF DESCRIPTION OF THE DRAWINGS

FIG. 1 is a schematic cross-sectional view showing manufacturing steps of a mold according to an embodiment.

FIG. 2 is an explanatory view showing an outline of a result of composition analysis in a layer thickness direction of a hard mask layer in a mold blank according to an embodiment.

FIG. 3 is an explanatory view showing a result of an observation by a scanning electron microscope regarding a mold formation pattern in examples 1 and 2, wherein (a) is a view showing an observation result of example 1, and (b) is a view showing an observation result of example 2.

FIG. 4 is an explanatory view showing a result of a composition analysis of the hard mask layer in examples 1, 3, and 4, wherein (a) is a view showing an analysis result regarding O, and (b) is a view showing an analysis result regarding N.

FIG. 5 is an explanatory view showing a result of a composition analysis of the hard mask layer in examples 3, 5, 6, and 7, wherein (a) is a view showing an analysis result regarding example 5, and (b) is a view showing an analysis result regarding example 6, and (c) is a view showing an analysis result regarding example 3, and (d) is a view showing an analysis result regarding example 7.

FIG. 6 is an explanatory view showing a result of a composition analysis of the hard mask layer in examples 1, 4, 8, and 9, wherein (a) is a view showing an analysis result regarding example 1, and (b) is a view showing an analysis result regarding example 8, and (c) is a view showing an analysis result regarding example 4, and (d) is a view showing an analysis result regarding example 9.

### DETAILED DESCRIPTION OF THE INVENTION

An embodiment of the present invention will be described hereafter, based on the drawings.

In this embodiment, explanation is given by classifying items in the following order.

1. Constitutional example of a mold blank

2. Procedure of a method of manufacturing the mold blank

3. Procedure of a method of manufacturing a mold using the mold blank

4. Effect of this embodiment

5. Modified example, etc.

<1. Constitutional Example of a Mold Blank>

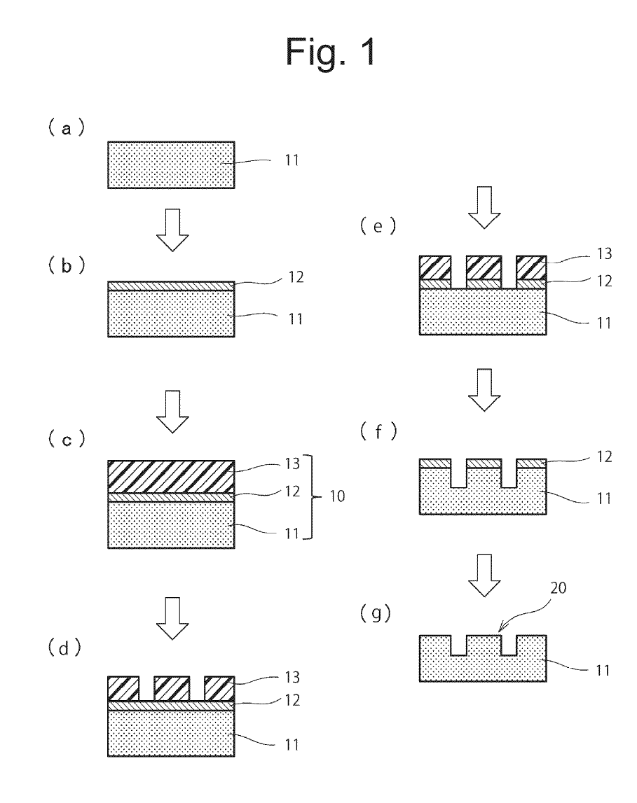

As shown in FIG. 1(c), a mold blank 10 for imprint given in this embodiment (called simply a “mold blank” hereafter) is obtained by sequentially forming a hard mask layer 12 and a resist layer 13 on a substrate 11.

The substrate 11 becomes a master mold or a copy mold, by forming an irregular pattern thereon as described later in detail.

The hard mask layer 12 is a mask material when the irregular pattern is formed on the substrate 11 by etching, and as described later in detail, the hard mask layer 12 is the most characteristic constituting feature in the mold blank 10 of this embodiment.

The resist layer 13 is the layer on which a resist pattern is formed by a specific pattern exposure and development, or transfer of the irregular pattern from an original mold. Based on the resist pattern, the irregular pattern is formed on the substrate 11.

This embodiment shows an example of a case that the mold blank 10 is formed by having the resist layer 13. However, it is necessary that the mold blank 10 has at least the hard mask layer 12 on the substrate 11. In this case, the resist layer 13 is separately formed on the hard mask layer 12 when the master mold or the copy mold is manufactured using the mold blank 10.

<2. Procedure of a Method of Manufacturing a Mold Blank>

The mold blank 10 configured as described above, is manufactured by a procedure described below.

(Preparation of a Substrate)

When the mold blank 10 is manufactured, first, the substrate 11 is prepared as shown in FIG. 1(a).

The substrate 11 may be used if it can be used as the master mold or the copy mold, and for example, a quartz (SiO₂) substrate or a silicon (Si) substrate is probably used. More specifically, for example when the substrate 11 is used as a mold for performing optical imprint, use of the SiO₂ substrate which is a translucent substrate can be considered from a viewpoint of light irradiation toward a transfer material. Further, for example when the substrate 11 is used as a mold for performing thermal imprint, use of the Si substrate having a resistance to a chlorine gas used for dry etching can be considered. Note that in a case of the thermal imprint, SiC substrate can be used instead of the Si substrate.

The shape of the substrate 11 is preferably a disc shape. When resist coating is performed, uniform coating utilizing a rotation can be performed. However, the shape of the substrate 11 is not limited to the disc shape, and may be other shape such as a rectangular shape, a polygonal shape, and a semi-circular shape, etc.

(Formation of the Hard Mask Layer)

After the substrate 11 is prepared, subsequently, as shown in FIG. 1(b), the hard mask layer 12 is formed on the substrate 11. The “hard mask layer” in this embodiment is composed of a single or multiple layers, and indicates a layer state used as a mask when etching is applied to a groove on the substrate 11.

In this embodiment, the hard mask layer 12 is formed separately in a first step and a second step.

In the first step, the substrate 11 is introduced into a sputtering apparatus, and a chromium nitride (CrN) layer is formed on the substrate 11 as the hard mask layer 12 by performing sputtering with a chromium target using a mixed gas of argon and nitrogen. Namely, in the first step, a CrN layer is formed on the substrate 11, the CrN layer having a composition containing chromium (Cr) and nitrogen (N). The CrN layer may be formed by performing sputtering with the chromium nitride target using an argon gas.

The reason for forming the composition containing Cr is as follows: the resistance to etching performed to the substrate 11 can be obtained, and the electro-conductivity for preventing a charge-up during the electron beam-drawing. Further, the composition containing Cr is preferable in a point that the hard mask layer 12 after use can be easily removed (peeled-off). However, a metal material is not necessarily limited to Cr, and other metal material such as Al, Ta, Si, W, Mo, Hf, and Ti, etc., may also be contained to form the composition, if the material has a resistance to etching and electro-conductivity.

Also, the reason for forming the composition containing N is as follows: this composition has a function of suppressing oxidation in the layer by nitrogen. However, a composition containing other element such as H, C, and B, etc., is also acceptable, unless the abovementioned electro-conductivity and etching resistance, etc., are not inhibited, while exhibiting the function of suppressing oxidation. If the hard mask layer 12 has a structure of not containing N (for example Cr film), it can be considered that the whole body of the layer is oxidized, in a film thickness that functions as the hard mask layer 12. If the whole body of the hard mask layer 12 is oxidized, the electric-conductivity is not secured and it is difficult to perform drawing, although the adhesion to the upper layer (resist) can be secured, and in a case of a high content of Cr, high etching rate cannot be obtained, and as a result, the fine pattern cannot be formed.

Then, in the second step performed subsequently to the first step, bake treatment is applied to the CrN layer formed in the first step, to thereby oxidize the CrN layer. At this time, N in the CrN layer has a function of suppressing the oxidation in the layer. Accordingly, the oxidized portion in the layer of the CrN layer is not spread over the whole body of the hard mask layer in the layer thickness direction, and stops in the vicinity of the surface area of the CrN layer. Namely, in the second step, the oxidized portion is formed in the vicinity of the surface area on the opposite side of the substrate 11 in the hard mask layer 12, and N contained in the CrN layer is made to function as the oxidation inhibiting material, to thereby suppress the spread of the oxidized portion over the whole body of the hard mask layer in the layer thickness direction. Note that formation of the oxidized portion is not necessarily limited by the bake treatment, and the oxidized portion may be formed by forming an oxidized film for example on the CrN layer.

By passing through the first step and the second step, the hard mask layer 12 has the composition containing Cr which is the metal material having resistance to etching and electro-conductivity, and the oxidized portion is formed in the vicinity of the surface area on the opposite side of the substrate 11, having the structure containing N in the area of the side of the substrate 11, as the oxidation inhibiting material for suppressing the spread of the oxidized portion over the whole body of the hard mask layer in the layer thickness direction.

Here, regarding the hard mask layer 12 having the structure containing Cr, N, and oxygen (O), the content variation of each composition in the layer thickness direction will be further specifically described.

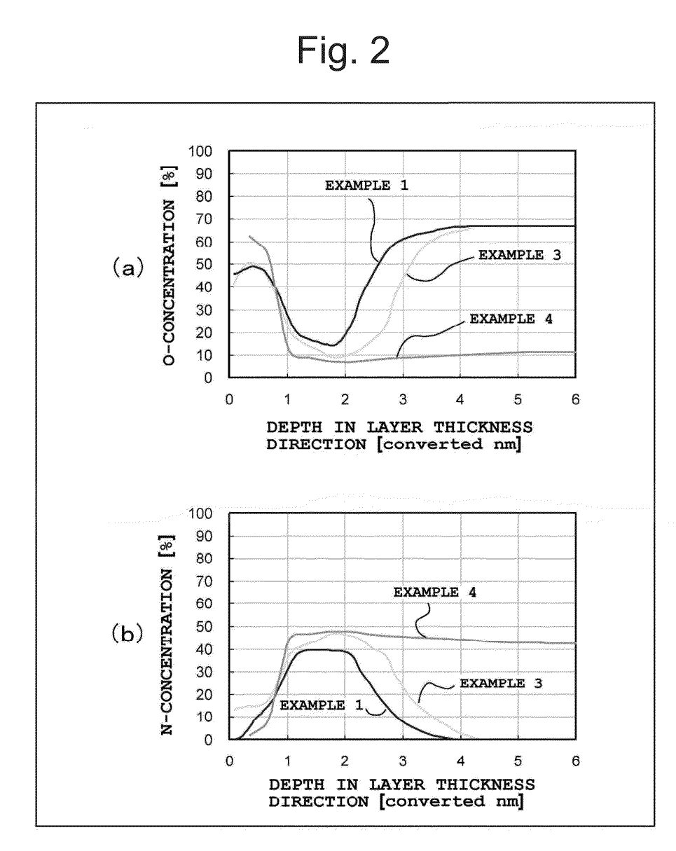

FIG. 2 is an explanatory view showing an outline of a result of a composition analysis in the layer thickness direction of the hard mask layer 12. In the example shown in the figure, the horizontal axis indicates a depth (nm) in the layer thickness direction of the hard mask layer 12, and the vertical axis indicates the content of each composition (atomic %, descried as “at %” hereafter), and the outline of the result of the composition analysis in a depth direction regarding each of N and O is shown.

According to the example shown in the figure, it is found that a state in which contains a large amount of O (so-called an O-rich state) by oxidation in the vicinity of the surface area of the hard mask layer 12, but the content of O is decreased according to the depth of the layer. It appears that this is because spread of the oxidation over the whole body of the hard mask layer 12 is suppressed by the function of N as the oxidation inhibiting material. Namely, the content of O in the hard mask layer 12 is varied in the layer thickness direction of the hard mask layer 12, so that the content of O is distributed to be higher toward the surface side.

The example shown in the figure shows a case that the variation of the content is continuous. However, for example when the oxidation is performed not by the bake treatment but by the formation of the oxide film, the variation of the content is not continuous but gradual. The “continuous” mentioned here means a state that the content is smoothly varied without generating a step toward a decreasing direction or an increasing direction. Further, the “gradual” means a state that the content is varied stepwise in an appearance of a step toward the decreasing direction and the increasing direction.

Meanwhile, it is found that N contained in the hard mask layer 12 is set in a state that a large amount of N is contained toward a deep layer side area of the hard mask layer 12 (namely the area on the side of the substrate 11), and the content of N is decreased on the surface side. It seems that this is because the content of N on the surface side is relatively decreased, with an increase of the content of O by oxidation on the surface side. Namely, the content of N in the hard mask layer 12 is distributed to be continuously or gradually varied so that the content of O is distributed to be high toward the deep layer side.

As described above, it can be said that the hard mask layer 12 has a content variation structure in which the content of N is continuously or gradually varied in the layer thickness direction, and the content of O is continuously or gradually varied substantially reversely to N in the layer thickness direction. In this content variation structure, the content of N is higher toward the deep layer side of the hard mask layer 12 (namely the side of the substrate 11), and the content of O is higher toward the surface side on the opposite side of the substrate 11.

“substantially reversely” mentioned here includes a case that each direction of the content variation (increasing/decreasing direction) are completely reversed directions, and also includes a case of the reversed directions as a whole that have the same directions partially but at the small area, although it cannot be said that these directions are completely the reversed directions.

An oxidation progress degree in the layer thickness direction of the hard mask layer 12 having such a content variation structure, is varied depending on an amount of N that functions as the oxidation inhibiting material. Specifically, progress of the oxidation is suppressed as the amount of N is increased, and the oxidized portion (oxide layer) in the vicinity of the surface area of the hard mask layer 12 becomes thin. If the oxide layer in the vicinity of the surface is thin, the electro-conductivity and a reflectance are maintained to be high. Then, if the electro-conductivity is maintained to be high, this is extremely suitable for preventing the charge-up when electron beam drawing is performed. Further, if the reflectance is maintained to be high, focusing can be easily performed when electron beam drawing is performed in manufacturing the master mold. As described above, in order to suppress the progress of oxidation in the layer thickness direction, it is preferable to set the content of N to 30 [at %] or more in the CrN layer before oxidation. With this structure, the hard mask layer 12 obtained after oxidation includes a portion where the content of N is 30 [at %] or more, and owing to the presence of the portion where a nitride degree is high, the electro-conductivity and the reflectance are maintained to be high.

In addition, even if the progress of oxidation in the layer thickness direction is suppressed by presence of N, the O-rich state is set by oxidation in the vicinity of the surface area. The oxidation of the hard mask layer is not preferable from the viewpoint of electro-conductivity, but it can be a merit from the viewpoint of the adhesion to the upper layer. Accordingly, in a case of the hard mask layer 12 having the abovementioned content variation structure, by limiting an oxidizing area to the vicinity of the surface area, the electro-conductivity and the reflectance are maintained to be high, and the adhesion between the hard mask layer 12 and the resist layer 13 formed on the upper layer side of the hard mask layer 12 can be sufficiently secured. This is considerably useful particularly for a use for an imprint technique. This is because in the imprint technique, there is a possibility that pattern transfer cannot be satisfactorily performed if the adhesion to the resist layer 13 cannot be secured.

Further, regarding the film thickness in forming the hard mask layer 12, thinning the film is desired to respond to a finer irregular pattern in the master mold, etc. Specifically, the film thickness of the hard mask layer is preferably set to 5 nm or less for example. The reason is as follows: the film thickness of 5 nm or less can be sufficiently respond to the formation of the fine irregular pattern (for example, the irregular pattern with a hole diameter of 25 nm and a pitch of 50 nm) , and the function as a mask can be sufficiently satisfied in a case of the etching of the fine irregular pattern (for example, a hole depth of about 100 nm), and further the time required for patterning of the hard mask layer 12 itself is not excessive.

In this embodiment, even in a case of the hard mask layer 12 having such a film thickness, the abovementioned content variation structure can be surely realized. Namely, the hard mask layer 12 having the abovementioned content variation structure can be formed by sequentially passing through the first step and the second step while utilizing the function of N which is exhibited as the oxidation inhibiting material, under no influence of a thin film thickness (namely even in a case of the film thickness of 5 nm or less).

(Formation of the Resist Layer)

After the hard mask layer 12 is formed as described above, subsequently as shown in FIG. 1(c), the resist layer 13 is formed on the hard mask layer 12. The resist layer 13 is formed for example by coating the hard mask layer 12 with resist for electron beam drawing. The resist suitable for the etching step performed thereafter, may be used as the resist for electron beam drawing. In this case, if the resist layer 13 is a positive resist, an electron beam drawn portion corresponds to a position of a groove on the substrate 11, and if the resist layer 13 is a negative resist, the electron beam drawn portion corresponds to an opposite position thereof.

Note that the resist layer 13 is not necessarily required to be formed by the resist for electron beam drawing, and may be formed by the resist for optical imprint for example. A light curing resin, and above all, ultraviolet-curing resin are given as the resist for optical imprint, and the resist suitable for the etching step performed thereafter may be used. Further, it can be considered that not the resist for optical imprint but the resist for thermal imprint is used.

The thickness of the resist layer 13 is preferably set to a thickness so as to be remained until the etching of the hard mask layer 12 is completed. The reason is as follows: when patterning the hard mask layer 12, the thickness of the resist layer 13 is decreased, and therefore the resist layer 13 is required to have a thickness in consideration of such a decrease of the thickness by etching.

The adhesion of the resist layer 13 thus formed, to the hard mask layer 12 is sufficiently secured by surface oxidation of the hard mask layer 12. Therefore, for example even in a case of the use for the imprint technique, the pattern transfer can be satisfactorily performed.

<3. Procedure of a Method of Manufacturing a Mold Using the Mold Blank>

Next, explanation is given for the procedure in a case of manufacturing the master mold or the copy mold using the mold blank 10 obtained by a manufacturing method including the following procedure.

(Pattern Drawing)

Here, first, explanation is given for a case that the resist pattern is formed by electron beam drawing.

In this case, the fine pattern is drawn on the resist layer 13 of the mold blank 10 using an electron beam drawing device. The fine pattern may be a micron-order, or may be a nano-order from a viewpoint of a performance of a recent electronic equipment, and the latter case is preferable in consideration of the performance of an end product.

Then, as shown in FIG. 1(d), after drawing the fine pattern, the resist layer 13 is developed and an electron beam drawn portion in the resist is removed, to form a resist pattern corresponding to a desired fine pattern. The position of the drawn fine pattern corresponds to the position of the groove which is finally processed on the substrate 11.

Note that after the electron beam drawing and the development are performed, descum processing for removing residual resist (scum) is performed as needed.

(Pattern Transfer)

Next, explanation is given for a case that the resist pattern is formed not by electron beam drawing but by pattern transfer from an original mold.

In this case, the original mold not shown is disposed on the resist layer 13. At this time, if the resist layer 13 is in a liquid state, the original mold may be simply placed on the liquid resist layer 13. Further, if the resist layer 13 is in a solid state, the original mold is pressed against the resist layer 13, and the fine pattern of the original mold may be transferred to the resist layer 13.

Thereafter, for example in a case of the optical imprint, the light curing resin is cured using an ultraviolet irradiation device, to thereby fix a fine pattern shape on the resist. At this time, irradiation of the ultraviolet ray is usually performed from the original mold side, but may also be performed from the substrate 11 side when the substrate 11 is a light translucent substrate.

In the pattern transfer, in order to prevent a transfer failure due to a positional deviation between the original mold and the mold blank 10, formation of a groove on the substrate may be prepared as an alignment mark on the substrate. Specifically, a mask aligner is set on the resist at the time of an exposure performed for transferring a fine pattern. By performing the exposure from above the mask aligner, the resist pattern can be formed, in which the resist in an alignment mark portion is removed.

After the fine pattern is transferred, the original mold is removed from the mold blank 10, and the pattern of the original mold is transferred on the resist on the mold blank 10. There is a case that a film not required for applying etching to the hard mask layer 12, exists on the transferred resist pattern in some cases. However, the unnecessary film is removed by ashing using plasma of a gas such as oxygen and ozone, etc. Thus, as shown in FIG. 1(d), the resist pattern is formed. Regarding the resist pattern, the groove is formed on the substrate 11 in a portion where the resist is not formed.

(First Etching)

After the resist pattern is formed, etching is performed to the hard mask layer 12 using the formed resist pattern as a mask, in each case of the electron beam drawing or the pattern transfer from the original mold. Specifically, the mold blank 10 after the resist pattern is formed, is introduced to a dry etching device, and dry etching is applied thereto using a chlorine gas or a mixed gas including the chlorine gas for example, to thereby partially remove the hard mask layer 12 while corresponding to a removed portion of the resist layer 13. By thus applying etching to the hard mask layer 12, as shown in FIG. 1(e), a hard mask pattern having the fine pattern is formed on the substrate 11. Note that an end point of the etching may be judged by using a reflection-type optical end point detector.

(Second Etching)

After the hard mask pattern is formed, dry etching is applied to the substrate 11 using a fluorine gas for example, in the same dry etching device after vacuum-exhausting the gas used in the abovementioned first etching. At this time, etching is applied to the substrate 11 using the hard mask pattern as a mask, so that groove processing corresponding to the fine pattern shown in FIG. 1(f) is applied to the substrate 11. Note that when the alignment mark is applied, the groove for the alignment mark is also formed on the substrate 11.

As the fluorine gas used here, CxFy (for example, CF₄, C₂F₆, C₃F₈), CHF₃, and a mixed gas of them, or a gas including rare gases (He, Ar, Xe, etc.) as an added gas can be given.

Thus, the groove processing corresponding to the fine pattern is applied to the substrate 11, and the hard mask layer 12 having the fine pattern is formed on a portion other than the groove of the substrate 11, and by removing the resist using an acid solution such as a sulfuric acid hydrogen peroxide mixture, a mold before removing the remained hard mask layer for the mold 20 for imprint is fabricated as shown in FIG. 1(f). Note that the resist may be removed before processing the substrate 11.

(Removal Etching Applied to the Remained Hard Mask Layer)

Thereafter, wet etching is applied to the mold before removing the remained hard mask layer. Specifically, first, the mold before removing the remained hard mask layer after removing the resist, is introduced to a wet etching device. Then, the hard mask pattern (namely the hard mask layer 12 remained on the substrate 11) is removed by performing wet etching using a cerium ammonium nitrate solution, to thereby remove the hard mask pattern (namely the hard mask layer 12 remained on the substrate 11). At this time, a mixed solution mixed with a perchloric acid may be used. A solution capable of removing the hard mask layer 12 may be used, other than the cerium ammonium nitrate solution. After the remained hard mask layer 12 is removed by etching, washing, etc., of the substrate 11 is performed as needed. Thus, the mold for imprint (namely the master mold or the copy mold) as shown in FIG. 1(g) is completed.

(Other Etching)

This embodiment shows examples of performing the first to second etchings, and removal etching applied to the remained hard mask layer. However, additional etching may be applied between etchings, according to a component of the mold blank 10.

Further, regarding the first and second etchings, wet etching may be employed instead of the dry etching. Specifically, in the first etching, similarly to the removal etching applied to the remained hard mask layer, the mixed solution of the cerium ammonium nitrate solution and the perchloric acid may be used. Also, in the second etching, when the substrate 11 is made of quartz, wet etching using fluoric acid may be performed. Conventionally, it is known that wet etching is anisotropic compared with dry etching, and the wet etching is not suitable for a method of processing a fine pattern. However, in a case of the hard mask layer in which the composition is continuously or gradually varied in the layer thickness direction, the etching rate can be varied in the layer thickness direction, and therefore by constituting the composition so that the etching rate is continuously or gradually varied from an upper layer portion to a lower layer portion, an anisotropic etching can be realized even in a case of the wet etching, and therefore the wet etching can be employed in the fine pattern processing. Actually, “upper layer: O-rich, lower layer: N-rich CrON film” according to an embodiment of the present invention is capable of realizing the abovementioned “anisotropic wet etching”.

Meanwhile, regarding the removal etching applied to the remained hard mask layer, not the wet etching but the dry etching may be performed. A basic procedure of the removal etching applied to the remained hard mask layer, the gas used for dry etching for removing the hard mask layer 12, and a mechanism of a progress of the dry etching, are the same as the abovementioned first etching (dry etching).

Further, any one of the etchings may be performed as the wet etching as described in this embodiment, or dry etching may be performed in other etching, or wet etching or dry etching may be performed in all etchings. Further, wet etching may be introduced according to a pattern size, in such a manner that when the pattern size is a micron-order, wet etching is performed in the stage of the micron-order, and dry etching is performed in the stage of a nano-order.

<4. Effect of this Embodiment>

According to the mold blank 10 and the method of manufacturing the same described in this embodiment, the following effect can be obtained.

According to this embodiment, the hard mask layer 12 in the mold blank 10 has the structure in which the content of N is continuously or gradually varied in the layer thickness direction, and the content of O is continuously or gradually varied substantially reversely to N in the layer thickness direction. In such a content variation structure, even if there is generated a portion where the content of O is high by oxidation of the hard mask layer 12, the spread of the oxidation over the whole body of the hard mask layer 12 in the layer thickness direction can be suppressed, and therefore both of the electro-conductivity and the adhesion of the hard mask layer 12 can be secured, irrespective of the film thickness of the hard mask layer 12 (namely even in a case of any kind of film thickness).

Particularly, as described in this embodiment, according to the content variation structure in which the content of N is higher toward the side of the substrate 11, and the content of O is higher toward the surface side on the opposite side of the substrate 11, the influence of the surface oxidation of the hard mask layer 12 is prevented from being spread over the whole body of the hard mask layer 12 in the layer thickness direction. Accordingly, this structure is considerably preferable for securing the adhesion between the hard mask layer 12 and the resist layer 13 corresponding to the upper layer of the hard mask layer 12, while securing the electro-conductivity in the hard mask layer 12.

As described in this embodiment, the abovementioned structure is realized in such way that N has the function of suppressing the oxidation in the layer of the hard mask layer 12, and O has the function of improving the adhesion to the resist layer 13 when the resist layer 13 is formed on the surface of the hard mask layer 12. Namely, by having the abovementioned content variation structure regarding N and O in the hard mask layer 12, both of the electro-conductivity and the adhesion can be secured in the hard mask layer 12.

Further, the hard mask layer 12 having the abovementioned content variation structure, is extremely easily respond to thinning the film thickness, compared with a case of a layered film structure. Accordingly, as described in this embodiment, the film thickness of the hard mask layer 12 can be easily set to 5 nm or less. Thus, if the film thickness of the hard mask layer 12 is set to 5 nm or less, it is possible to sufficiently respond to the formation of the fine irregular pattern in the master mold, etc., and the function as the mask can be sufficiently exhibited to the etching of the fine irregular pattern, and further the time required for the patterning of the hard mask layer 12 itself is not excessive. In addition, even when the film thickness is set to 5 nm or less, both of the electro-conductivity and the adhesion of the hard mask layer 12 can be secured if the hard mask layer 12 having the structure described in this embodiment is used.

Further, as descried in this embodiment, if quartz or silicon is used for the substrate 11, the mold blank 10 suitable for manufacturing the master mold or the copy mold can be constituted. This is because such a master mold, etc., can be used for the optical imprint or the thermal imprint, etc., and further can be used for a nano-imprint technique. Particularly, this embodiment can be suitably applied to DTR media and BPM fabricated using the nano-imprint technique.

Further, as described in this embodiment, according the structure in which the hard mask layer 12 includes the portion in which the content of N is 30 [at %] or more, the oxidized portion (oxide layer) in the vicinity of the surface can be suppressed to be thin, and the electro-conductivity and the reflectance in the hard mask layer 12 can be maintained to be high. Accordingly, the mold blank 10 thus constituted is considerably suitable for preventing the charge-up when electron beam drawing is performed, and further focusing can be easily performed when electron beam drawing is performed.

As described in this embodiment, the hard mask layer 12 is etched using the resist pattern formed from the resist layer 13 as a mask. Here, the difference of the etching rate between the resist layer 13 and the hard mask layer 12 is usually smaller than the difference of the etching rate between the hard mask layer 12 and the substrate 11. Namely, when the composition of the hard mask layer 12 is examined from a viewpoint of an etching resistance, an etching selection ratio to the resist layer 13 (rather than the substrate 11) is usually focused in the examination, from a viewpoint of the etching resistance. From this viewpoint, it is found that the etching rate becomes larger as the content of N [at %] of the hard mask layer 12 becomes larger. Therefore, by setting a large content of N [at %], the resist layer 13 can be thinner than the layer thickness of the hard mask layer 12, and this is preferable from the viewpoint of forming the fine pattern.

As described in this embodiment, the mold blank 10 capable of obtaining the abovementioned effect can be easily and surely manufactured by forming the hard mask layer 12 through the first step and the second step. Namely, in the first step, the CrN layer is formed on the substrate 11, and in the second step, the vicinity of the surface area of the CrN layer is oxidized and N contained in the CrN layer is made to function as the oxidation inhibiting material, to thereby suppress the spread of the oxidation over the whole body of the hard mask layer 12 in the layer thickness direction. Thus, by utilizing the function of N as the oxidation inhibiting material, the hard mask layer 12 having both of the electro-conductivity and adhesion can be easily and surely obtained. As a result, the master mold and the copy mold in which the fine irregular pattern is formed with high precision can be obtained.

<5. Modified Example, etc.>

As described above, the embodiment of the present invention has been described. However, the abovementioned disclose content shows an exemplary embodiment of the present invention. Namely, a technical range of the present invention is not limited to the abovementioned exemplary embodiment.

A modified example other than the abovementioned embodiment will be described hereafter.

In the abovementioned embodiment, explanation is given for a case that the contents of N and O in the hard mask layer 12 are continuously and gradually varied in the layer thickness direction, and thus both of the electro-conductivity and adhesion can be secured. However, the hard mask layer 12 is not required to have the continuous or gradual content variation structure, and may have the structure as described below. Namely, the hard mask layer 12 may have a structure having a composition containing Cr which is a metal material having electro-conductivity and resistance to etching applied to the substrate 11, with the oxidized portion formed in the vicinity of the surface area on the opposite side of the substrate 11, and containing the oxidation inhibiting material in the area on the side of the substrate 11 for suppressing the spread of the oxidation over the whole body of the hard mask layer 12 in the layer thickness direction. In this structure as well, the adhesion to the resist layer 13 can be secured by the existence of oxidized portion in the vicinity of the surface area, while securing the electro-conductivity in the hard mask layer 12 by containing the oxidation inhibiting material.

In the hard mask layer 12 with this structure, N can be used as the oxidation inhibiting material, similarly to the case of the abovementioned embodiment. This is because N can surely exhibit the oxidation inhibiting function and does not inhibit the electro-conductivity and the etching resistance, etc. Further, the layer made of the composition containing N can be easily formed by sputtering.

### EXAMPLE

The present invention will be specifically descried based on examples. However, it is a matter of course that the present invention is not limited to the following examples.

### Example 1

In example 1, a disc-shaped synthetic quartz substrate (having an outer diameter of 150 mm and a thickness of 0.7 mm) was used as the substrate 11 (see FIG. 1(a)). This substrate (called a “quartz substrate” hereafter) 11 was introduced to a sputtering device.

Then, sputtering was performed to a chromium target using a mixed gas of argon and nitrogen (Ar:N₂ flow rate =70:30, described as “nitrogen flow rate 30%” hereafter) without performing air exposure, to thereby form a layer made of CrN (called a “CrN layer” hereafter) with a thickness of 2.3 mm. Thereafter, bake treatment was applied to the formed CrN layer in the atmosphere at 200° C. for 15 minutes and the surface side of the CrN layer was oxidized, to thereby form the hard mask layer (see FIG. 1(b)).

After such a hard mask layer 12 was formed, the hard mask layer 12 was coated with a resist material at 45 Nm thickness for electron beam drawing (ZEP520A by ZEON Corporation) by spin coating, and bake treatment was applied thereto, to thereby form the resist layer 13 (see FIG. 1(c)).

Subsequently, a dot pattern with a hole diameter of 13.4 nm and a pitch of 25 nm was drawn on the resist layer 13 formed on the hard mask layer 12 using an electron beam drawing machine (pressurized voltage of 100 kV), and thereafter the resist layer 13 was developed, to thereby form a resist pattern corresponding to a fine pattern (see FIG. 1(d)).

Subsequently, the quartz substrate 11 having the hard mask layer 12 formed thereon, was introduced to the dry etching device, and dry etching was applied thereto using a Cl₂/O₂ gas. Thus, an unnecessary portion in the hard mask layer 12 was removed, and the fine pattern was formed (see FIG. 1(e)). Then, the resist pattern was removed using a sulfuric acid hydrogen peroxide mixture composed of a concentrate sulphuric acid and a hydrogen peroxide solution (concentrated sulphuric acid:hydrogen peroxide solution=2:1 (volume ratio)).

Further, after the gas used in dry etching applied to the hard mask layer 12 was vacuum-exhausted, dry etching was applied to the quartz substrate 11 by a fluorine gas (CHF₃:Ar=1:9 (volume ratio)), using the remained hard mask layer 12 as a mask. Here, etching treatment was applied to the quartz substrate 11 using the hard mask layer 12 as a mask, and a hole corresponding to the fine pattern was formed on the quartz substrate (see FIG. 1(f)).

After hole processing was thus applied to the quartz substrate 11, wet etching was applied to the hard mask layer 12 remained on the quartz substrate 11 using cerium ammonium nitrate.

Washing treatment and dry treatment, etc., were performed through the abovementioned step, to thereby fabricate an imprint mold of this example.

### Example 2

In example 2, the CrN layer made of CrN (nitrogen flow rate 30%) was formed with a thickness of 2.3 nm, to thereby form the hard mask layer 12. Then, a dot pattern with a hole diameter of 16.4 nm and a pitch of 30 nm was drawn on the resist layer 13 on the hard mask layer 12, to thereby form a resist pattern. The imprint mold of this example was fabricated under the same condition as the case of example 1 other than the abovementioned point. Namely, example 2 is different from the case of example 1 in the hole diameter and the pitch.

### Example 3

In example 3, the CrN layer made of CrN (nitrogen flow rate 30%) was formed with a thickness of 2.8 nm, to thereby form the hard mask layer 12. The imprint mold of this example was fabricated under the same condition as the case of example 1 other than the abovementioned point. Namely, example 3 is different from the case of example 1 in the film thickness of the hard mask layer 12.

### Example 4

In example 4, the CrN layer made of CrN (nitrogen flow rate 30%) was formed with a thickness of 10.0 nm, to thereby form the hard mask layer 12. The imprint mold of this example was fabricated under the same condition as the case of example 1. Namely, example 4 is different from the case of example 1 in the film thickness of the hard mask layer 12.

### Example 5

In example 5, the CrN layer made of CrN (nitrogen flow rate 10%) was formed with a thickness of 2.8 nm, to thereby form the hard mask layer 12. The imprint mold of this example was fabricated under the same condition as the case of example 3 other than the abovementioned point. Namely, example 5 is different from the case of example 3 in the nitrogen flow rate in the hard mask layer 12.

### Example 6

In example 6, the CrN layer made of CrN (nitrogen flow rate 20%) was formed with a thickness of 2.8 nm, to thereby form the hard mask layer 12. The imprint mold of this example was fabricated under the same condition as the case of example 3 other than the abovementioned point. Namely, example 6 is different from the cases of examples 3 and example 5 in the nitrogen flow rate in the hard mask layer 12.

### Example 7

In example 7, the CrN layer made of CrN (nitrogen flow rate 50%) was formed with a thickness of 2.8 nm, to thereby form the hard mask layer 12. The imprint mold of this example was fabricated under the same condition as the case of example 3 other than the abovementioned point. Namely, example 7 is different from the cases of examples 3, example 5, and example 6 in the nitrogen flow rate in the hard mask layer 12.

### Example 8

In example 8, the CrN layer made of CrN (nitrogen flow rate 10%) was formed with a thickness of 2.3 nm, to thereby form the hard mask layer 12. The imprint mold of this example was fabricated under the same condition as the case of example 1 other than the abovementioned point. Namely, example 8 is different from the case of example 1 in the nitrogen flow rate in the hard mask layer 12.

### Example 9

In example 9, the CrN layer made of CrN (nitrogen flow rate 10%) was formed with a thickness of 10.0 nm, to thereby form the hard mask layer 12. The imprint mold of this example was fabricated under the same condition as the case of example 4 other than the abovementioned point. Namely, example 9 is different from the case of example 4 in the nitrogen flow rate in the hard mask layer 12.

<Evaluation 1>

Regarding the abovementioned examples 1 and 2, a formed pattern on the quartz substrate was observed using a scanning electron microscope.

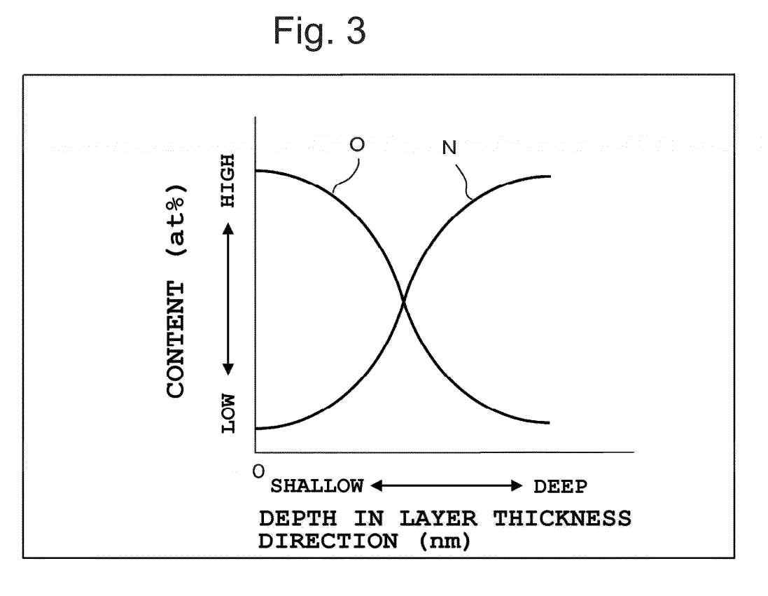

As a result of the observation by the scanning electron microscope regarding the formation pattern of the quartz substrate 11 in examples 1 and 2, it is found that a fine irregular pattern is formed with high precision without generating a pattern defect as shown in FIG. 3(a) and FIG. 3(b), although the thickness of the hard mask layer 12 is 2.3 nm. It is thought that this is because in the hard mask layer 12, the electro-conductivity required for preventing the charge-up at the time of electron beam drawing is secured, and further the adhesion to the resist layer 13 or the resist pattern is secured.

<Evaluation 2>

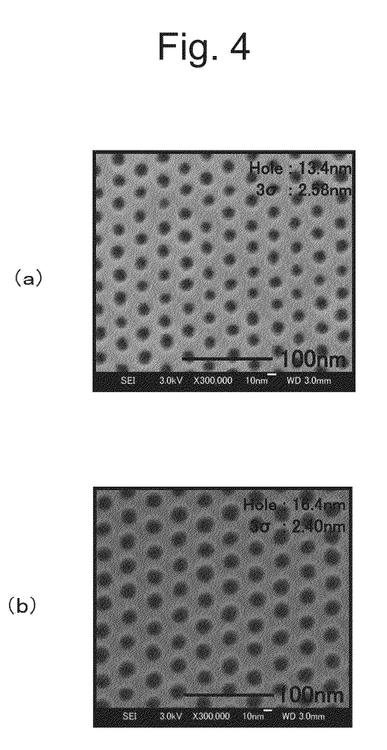

In the abovementioned examples 1, 3, and 4, the composition of the hard mask layer 12 in the layer thickness direction was analyzed using an X-ray Reflectometer (called “XRP” hereafter) and a High resolution Rutherford Backscattering Spectrometry (called “HR-RBS” hereafter). Specifically, film thickness measurement by XRP was performed to a sample with the hard mask layer 12 formed on the quartz substrate 11, and further composition analysis was performed thereto by HR-RBS. The HR-RBS analysis was performed regarding five elements, of which Si, Cr, O, and N were elements considered to be contained in the quartz substrate 11 and the hard mask layer 12, and of which C was possibly adhered to the quartz substrate 11 and the hard mask layer 12 at the time of the air exposure, to thereby obtain the content of the five elements. In FIG. 4 showing an analysis result, the vertical axis indicates the content of the composition element, namely the concentration (at %) in the layer of the composition element. Further, the horizontal axis indicates a distribution position of the composition element by converting it to nm (unit: [converted nm]), from a value obtained by the film thickness measurement by XRP and a value of 2.65 g/cm³ which is a virtual low density in the quartz substrate 11 (source: physics and chemistry dictionary), wherein a position where the Cr concentration is half of a peak concentration, is set as an interface between the quartz substrate 11 and the hard mask layer 12. Namely, the distribution position in the layer thickness direction does not necessarily coincide with an actual distance [nm], and a width of 1 [converted nm] in each data does not completely coincide with each other. Note that 0 [converted nm] of the depth in the layer thickness direction corresponds to the surface of the hard mask layer 12. In any one of the hard mask layers 12 of examples 1, 3, and 4, the O-rich state was set in the vicinity of the surface area, and the N-rich state was set in a deep layer area, and it was confirmed that the effect of the present invention could be obtained.

The compositions of the hard mask layers 12 in examples 1, 3, and 4, show the O-rich state in the vicinity of the surface area as shown in FIG. 4(a), and in examples 1 and 3, the content of O is continuously decreased and is increased again. This can be considered as follows: namely, the composition of the hard mask layer 12 is detected under an influence of O contained in the quartz substrate 11 which is a lower layer of the hard mask layer 12. Further, in example 4, the content of O is varied so as to continuously decrease toward the deep layer side, and thereafter is maintained in a low concentration state without turning upward again. It seems that this is because the hard mask layer 12 has an enough thickness so as not to be influenced by O which is contained in the lower layer (quartz substrate 11).

Meanwhile, in examples 1, 3, and 4, as shown in FIG. 4(b), there is a state in which the content of N is more increased toward the deep layer side than the surface side of the hard mask layer 12. In examples 1 and 3, the content of N is continuously increased and thereafter is decreased again corresponding to the content variation of O. In example 4 as well, the content of N is continuously increased and thereafter is maintained in a high concentration state corresponding to the content variation of O.

Namely, from the result of the composition analysis shown in FIG. 4(a) and FIG. 4(b), it is found that in any one of the examples 1, 3, and 4, the hard mask layer has a content variation structure in which the contents of O and N are mutually reversely varied, irrespective of the film thickness of the hard mask layer 12.

<Evaluation 3>

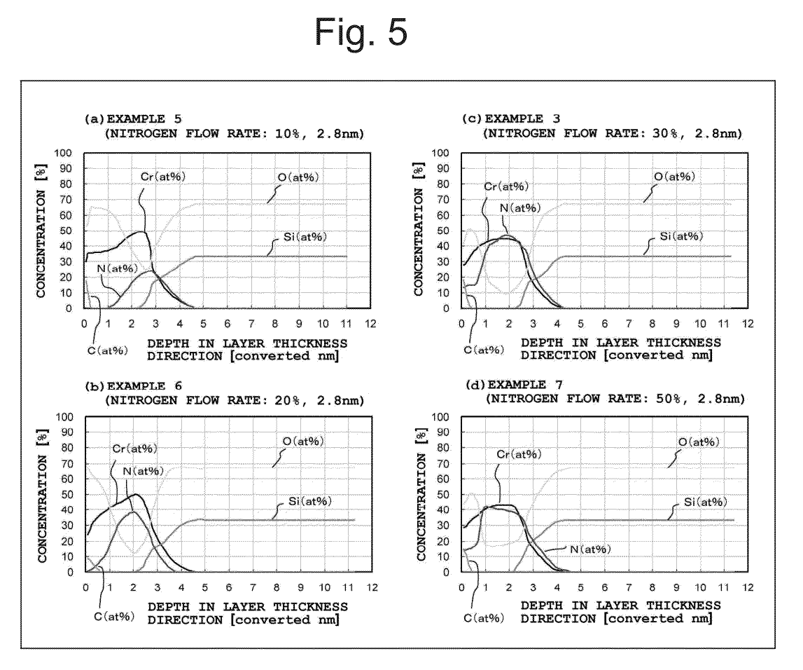

In examples 3, 5, 6, and 7, the composition of the hard mask layer 12 in the layer thickness direction was analyzed using the XRP and the HR-RBS. Namely, the composition analysis was performed for examining the influence by the variation of the N-concentration when the film thickness of the hard mask layer 12 is fixed. The vertical axis and the horizontal axis in FIG. 5 showing the analysis result, are the same as those of FIG. 4. In any one of the hard mask layers 12 of examples 3, 5, 6 and 7, the O-rich state was set in the vicinity of the surface area, and the N-rich state was set in a deep layer area, and it was confirmed that the effect of the present invention could be obtained.

When the result of the composition analysis in example 5 shown in FIG. 5(a), the result of the composition analysis shown in FIG. 5(b), and the result of the composition analysis shown in FIG. 5(c) in example 3 are compared, it is found that the thickness of the oxidized portion in the vicinity of the surface area is more decreased in example 6 than example 5, and in example 3 than example 6 (namely as the nitrogen flow rate is higher). However, when the result of the composition analysis of example 3 and the result of the composition analysis of example 7 shown in FIG. 5(d) are compared, no large difference is recognized in the thickness of the oxidized portion in the vicinity of the surface. Therefore, it can be said that a large nitrogen flow rate is preferable for suppressing the thickness of the oxidized portion (oxide layer) to be thin in the vicinity of the surface area, and specifically 30% or more nitrogen flow rate is preferable. Regarding the N-concentration contained in the hard mask layer 12 obtained as the result of the HR-RBS analysis as well, 30 [at %] or more content of N in the hard mask layer 12 would be preferable.

Note that the oxidized portion in the vicinity of the surface is the portion where oxidation is generated in the hard mask layer 12 and the O-concentration is a prescribed value or more, and the thickness of the oxidized portion is a depth in the layer thickness direction from the surface of the hard mask layer 12 to a part where the O-concentration is a specific value. The specific value of the O-concentration may be a previously defined value, and a variable value like a lower limit value of the O-concentration that varies in the layer thickness direction may be used, or a fixed value such as O-concentration 30 [at %] may be used.

<Evaluation 4>

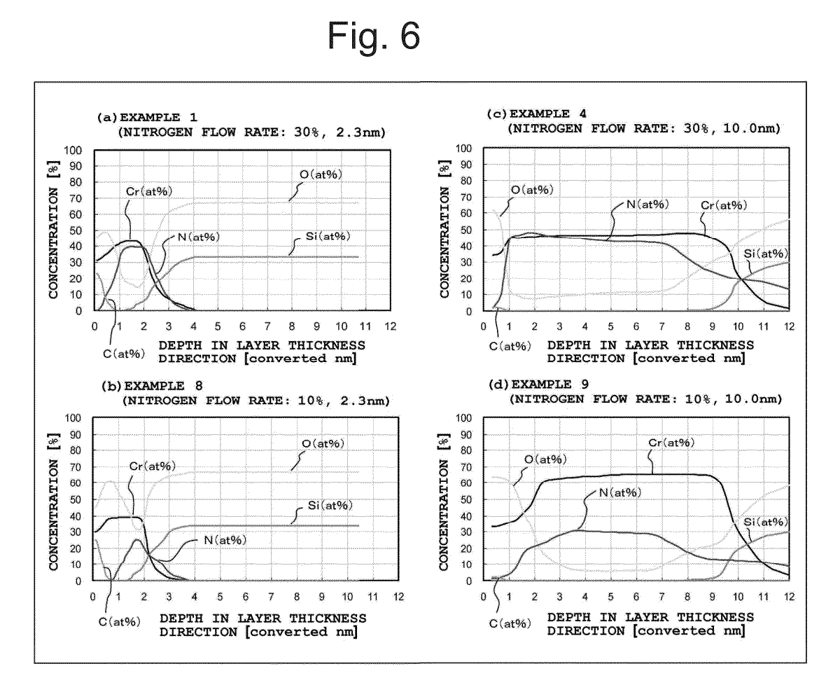

In each of the examples 1, 3, 4, 5, 8, and 9, the composition of the hard mask layers 12 in the layer thickness direction was analyzed using the XRP and the HR-RBS. Namely, composition analysis was performed to the hard mask layer 12 having the film thickness of 2.3 nm, 2.8 nm, and 10.0 nm respectively, so as to be compared with a case that the nitrogen flow rate was 30% and the case that the nitrogen flow rate was 10%. The vertical axis and the horizontal axis in FIG. 5 and FIG. 6 showing the analysis result are the same as those of FIG. 4. In any one of the hard mask layers, the O-rich state was set in the vicinity of the surface area, and the N-rich state was set in the deep layer area, and it was confirmed that the effect of the present invention could be obtained.

When the result of the composition analysis in example 1 shown in FIG. 6(a) and the result of the composition analysis in example 8 shown in FIG. 6(b) are compared, it is found that the thickness of the oxidized portion in the vicinity of the surface in example 1 is more decreased than a case of example 8 when the film thickness is 2.3 nm.

When the result of the composition analysis in example 3 shown in FIG. 5(c) and the result of the composition analysis in example 5 shown in FIG. 5(a) are compared, it is found that the thickness of the oxidized portion in the vicinity of the surface area is more decreased in example 3 than a case of example 5 when the film thickness is 2.8 nm.

When the result of the composition analysis of example 4 shown in FIG. 6(c) and the result of the composition analysis of example 9 shown in FIG. 6(d) are compared, it is found that the thickness of the oxidized portion in the vicinity of the surface is more decreased in example 4 than a case of example 9 when the film thickness is 10.0 nm.

Namely, in each case of the film thickness, it can be said that a larger content of N is preferable for suppressing the oxidized portion (oxide layer) in the vicinity of the surface.

<Conclusion>

From the results of the abovementioned evaluations 1 to 4, it is found that by employing the content variation structure of O and N in the hard mask layer 12 as shown in examples 1 to 9, both of the electro-conductivity and the adhesion of the hard mask layer 12 can be secured even in a case of responding to the thinning of the hard mask layer 12, and as a result, the fine irregular pattern can be formed on the substrate 11 with high precision.

### DESCRIPTION OF SIGNS AND NUMERALS

10 Mold blank
11 Substrate (quartz substrate)
12 Hard mask layer
13 Resist layer
20 Mold for imprint

1. A mold blank comprising a substrate and a hard mask layer formed on the substrate as a mask material when etching is applied to the substrate, wherein the hard mask layer has a composition containing chromium, nitrogen, and oxygen and has a content variation structure in which content of the nitrogen is varied continuously or gradually in a layer thickness direction and content of the oxygen is varied in the layer thickness direction continuously or gradually substantially in an opposite direction to the nitrogen.

2. The mold blank according to claim 1, wherein in the content variation structure, the content of the nitrogen is high toward the substrate, and the content of the oxygen is high toward a surface opposite to the substrate.

3. The mold blank according to claim 2, wherein the nitrogen has a function of inhibiting oxidation in a layer, and the oxygen has a function of improving an adhesion when a resist layer is formed on a surface.

4. The mold blank according to claim 3, wherein a film thickness of the hard mask layer is 5 nm or less.

5. The mold blank according to claim 3, wherein the substrate is made of quartz or silicon.

6. The mold blank according to claim 3, wherein the hard mask layer includes a portion in which the content of the nitrogen is 30 [at %] or more.

7. A mold blank comprising a substrate and a hard mask layer formed on the substrate as a mask material when etching is applied to the substrate, wherein the hard mask layer has a composition including a metal material having resistance to etching and electro-conductivity, and has an oxidized portion formed in the vicinity of a surface area on an opposite side of the substrate, and containing an oxidation inhibiting material in a substrate side area for inhibiting a spread of the oxidized portion over the whole body of the hard mask layer in a layer thickness direction.

8. The mold blank according to claim 7, wherein the oxidation inhibiting material is nitrogen.

9. A master mold, having an irregular pattern and formed of the mold blank described in claim 1.

10. A copy mold, having an irregular pattern and formed of the mold blank described in claim 1.

11. A method of manufacturing a mold blank comprising a substrate and a hard mask layer formed on the substrate as a mask material when etching is applied to the substrate, the method comprising:
a first step of forming the hard mask layer having a composition containing chromium and nitrogen on the substrate; and
a second step of forming an oxidized portion in the vicinity of a surface area on an opposite side of the substrate in the hard mask layer, and inhibiting a spread of the oxidized portion over the whole body of the hard mask layer in a layer thickness direction by making the nitrogen function as an oxidation inhibiting material.
